(19) United States
(12) Patent Application Publication
(10) Pub. No.: US 2026/0295879 A1
(43) Pub. Date: Oct. 1, 2026

(54) AXE AND A METHOD OF MANUFACTURING AN AXE

(71) Applicant: Fiskars Finland Oy Ab, Espoo (FI)

(72) Inventors: Mikko Kemppi, Espoo (FI); Jouni Riikonen, Espoo (FI); Kari Kunnas, Espoo (FI)

(73) Assignee: Fiskars Finland Oy Ab, Espoo (FI)

(21) Appl. No.: 19/704,660

(22) Filed: Jun. 11, 2026

Related U.S. Application Data
(62) Division of application No. 17/976,034, filed on Oct. 28, 2022.

(30) Foreign Application Priority Data
Nov. 5, 2021 (EP) 21206671.6

(51) Int. Cl. B26B 23/00; B25G 1/10; B25G 3/34

(52) U.S. Cl. CPC B26B 23/00; B25G 1/10; B25G 3/34

(57) ABSTRACT

A method for manufacturing an axe, the method comprising arranging an axe head into a mold, arranging a filling into the mold to contact the axe head, and arranging a curved core into the mold to contact the filling. The method includes introducing a melt mass to the mold to form a handle by surrounding the filling and the curved core and to partially surround the axe head with the melt mass. The method includes removing the curved core from the formed handle.

### CROSS-REFERENCE TO RELATED PATENT APPLICATIONS

This Application is a divisional of U.S. patent application Ser. No. 17/976,034, filed on Oct. 28, 2022, which claims the benefit of priority to European Patent Application No. 21206671.6, filed on Nov. 5, 2021. The complete disclosures of which are hereby incorporated by reference in their entireties.

### FIELD

This invention relates to an axe and to a method for manufacturing an axe.

### BACKGROUND

Previously there are known axes that have axe heads connected to axe handles. In these known solutions the axe handle has either a straight profile and/or is solid. The known solutions of axe handles are focused on securing the grip of the user with various configurations of widenings, protrusions, recesses, and surface materials, instead of the ergonomics of the user's grip viewed in light of the user's wrist position.

The above mentioned known axes are traditionally manufactured by inserting a separately manufactured straight handle through a hole in an axe head, thus securing said parts together. These separately manufactured handles are traditionally manufactured by i.e. carving wood, casting metal, or injection molding plastic. Known ways to utilize above mentioned manufacturing methods in axe handle manufacturing either restrict the shape of the handle, or the construct of the handle forcing the handle to be solid.

A disadvantage with an axe handle as described above is that a straight handle forces the user's wrist to be in a disadvantaged position when using the axe. This can make the use of the axe less efficient or cause unnecessary stress on the user's body when frequently used over a long period of time. Additionally, the weight of solid axe handles makes the axe less user friendly and less portable. Also, the manufacture of a solid axe handle requires more raw materials, and increases the throughput time of the process.

### SUMMARY

An object of the present invention is to solve the above mentioned disadvantages and to provide an axe which has excellent properties during use and is easy to manufacture reliably. These and other objects are achieved with an axe and with a manufacturing method.

When the gripping end of an axe handle comprises a curved tubular portion, the gripping end is in an advantageous position for use resulting in improved usability and ergonomics.

Preferred embodiments of the invention are disclosed in the dependent claims.

### BRIEF DESCRIPTION OF THE DRAWINGS

In the following the present invention will be described in closer detail by way of example and with reference to the attached drawings, in which

FIG. 1 illustrates a perspective view of an embodiment of the invention,

FIG. 2 illustrates a back view of the embodiment of FIG. 1,

FIG. 3 illustrates a side view of the cross section B-B of the FIG. 2,

FIG. 4 illustrates a side view of the embodiment of FIG. 1,

FIG. 5 illustrates a back view of the cross section A-A of the FIG. 4,

FIG. 6 illustrates a back view of the embodiment of FIG. 1, with a curved core still inside the handle, and

FIG. 7 illustrates a side view of the cross-section B-B of the FIG. 6.

FIG. 8 illustrates a flowchart of an example method for manufacturing an axe.

### DETAILED DESCRIPTION

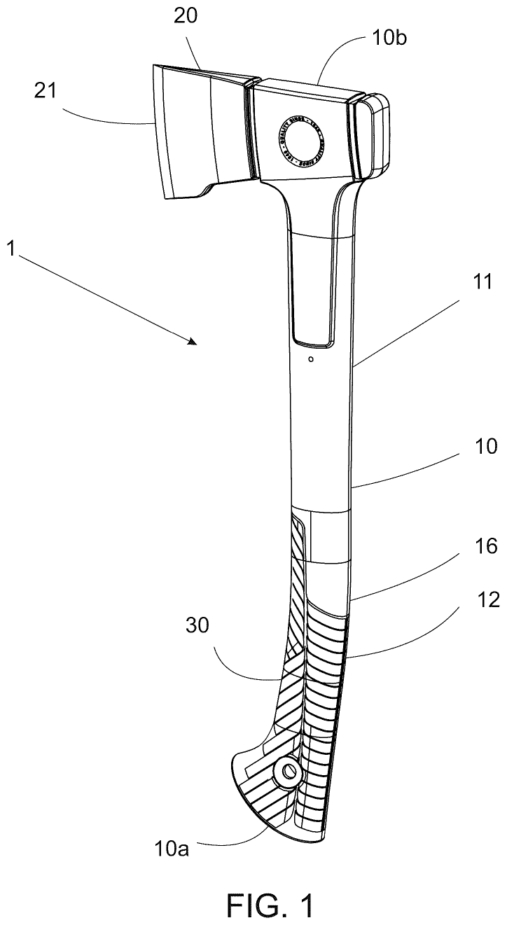

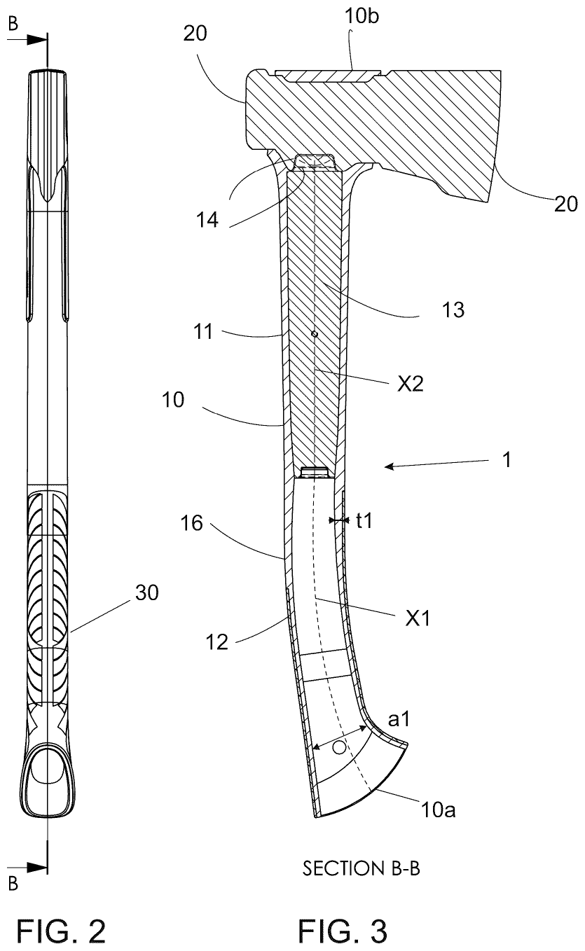

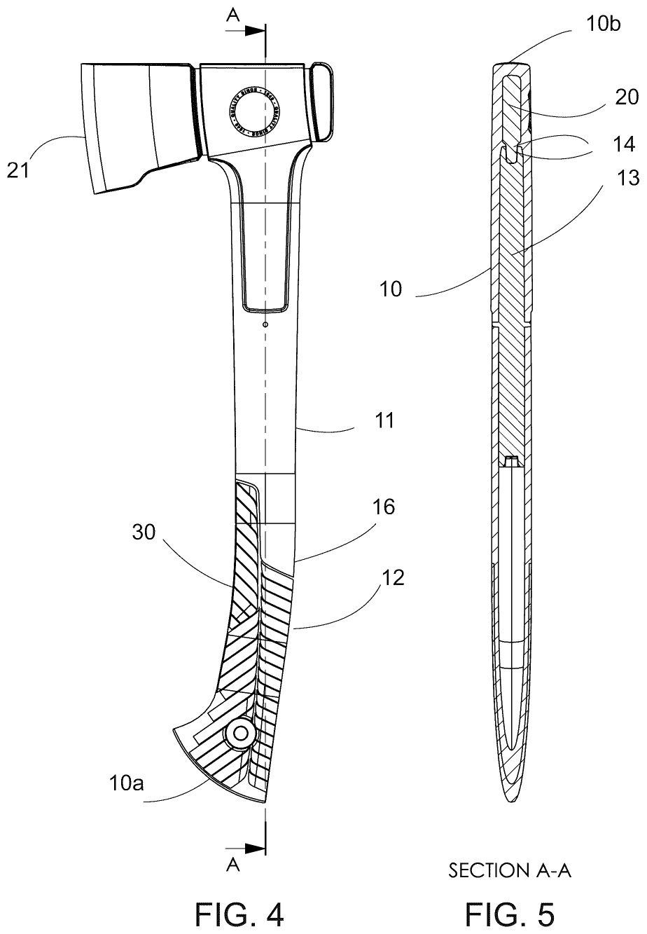

FIGS. 1 to 5 illustrate an embodiment of an axe 1 comprising a handle 10 with a first gripping end 10a, and an axe head 20 in a second end 10b of the handle 10, the axe head 20 comprising an edge 21 defining the striking direction of the axe 1. The edge 21 and the striking direction further define a striking plane, in respect to which the axe 1 is preferably symmetrical. The handle 10 further comprises a straight tubular portion 11 comprising a filling, and a curved tubular portion 12 which is curved on the striking plane defined by the striking direction of the axe 1. The curvature of the curved tubular portion 12 is in the striking plane and preferably towards the striking direction. Consequently, the curved tubular portion extends from the straight tubular portion 11 as a curve towards the striking direction. The tubularity of the curved portion 12 without a filling allows the axe 1 to be lighter, and the curvature of the curved portion 12 allows the user to grip the handle 10 with a more advantageous wrist position. Another advantage of the curved tubular portion 12 is that the center of gravity of the axe 1 is moved further along the handle 10 of the axe 1 towards the axe head 20 making the axe more efficient and more maneuverable.

In the embodiment of FIGS. 1 to 5, the filling of the straight tubular portion 11 is formed with a filling part 13 visible in FIGS. 3, 5, and 7, which filling part 13 is separate and premade. Alternatively, instead of using a separate filling part 13, the filling may also be filled during the manufacture process of the handle 10 using the same material as the material of the handle 10. However, using a separate pre-fabricated filling part 13 is advantageous for surface quality of the handle 10, as it allows the tubular portions of the handle 10 to have a substantially constant wall thickness t1. The curing time of the handle 10 is also shortened when a separate filling part 13 is used, as there is no need to wait for the filling to be cured. Additionally, as the filling part 13 remains hidden in regular use, waste material left over from other manufacturing may be used as the raw material for the filling part 13.

In the embodiment of FIGS. 1 to 5 said filling part 13 is positioned relative to the axe head 20 with mating positioning elements visible in FIGS. 3, 5, and 7. In the embodiment the mating positioning elements are particularly compatible recess/protrusion elements delimiting relative movement of said parts. The filling part 13 having a recess receiving a protrusion of the axe head 20 visible in FIG. 5, restricting relative sideways movement of the parts, in respect to the striking plane. Respectively, as is visible in cross section B-B in FIGS. 3 and 7, the axe head 20 has a recess into which the filling part 13 protrudes, restricting the relative movement of the parts in striking direction. Other positioning elements may also be used such as conical elements or other generally known ways of aligning parts. These positioning elements allow the subparts to be easily positioned in accurate positions when the axe 1 is manufactured, making the process faster, more efficient, and more accurate.

In the embodiment of FIGS. 1 to 5, the filling part 13 is solid, which is visible in FIGS. 3, 5, and 7. Advantages of using a solid filling part 13 is its ease of manufacture. Alternatively, the filling part 13 may have a hollow construct or have an infill. Such filling parts 14 with a hollow structure or an infill can be manufactured with for example additive manufacturing. These options would reduce the weight of the filling part 13, and thus reduce the weight of the axe 1.

In the embodiment of FIGS. 1 to 5, the tubular curved portion 12 comprises a section with a substantially constant wall thickness. Optionally, the wall thickness of all tubular portions of the handle 10 may have a substantially constant wall thickness. The more constant the wall thickness, the more evenly the handle 10 is cured, thus increasing quality of the handle 10.

In the embodiment of FIGS. 1 to 5, the top line 16 of the curved portion 12 at least partially follows a circular path on said striking plane defined by the striking direction of the axe 1. The curvature of the top line 16 allows the wrist to be set in a natural position when grabbing the axe 1, as the wrist sits on the top line 16 when the axe 1 is used. Top line in this context means the side of the axe handle 10, which faces away from the striking direction, and is on top when the axe is struck when the edge 21 of the axe head 20 faces down. Additionally, this following of the circular path makes it easier to design and manufacture accurately the curved molds and cores used for manufacturing the axe 1. The angle between the first gripping end 10a of the handle 10 and the straight tubular portion 11 of the handle 10, formed by the curvature, is preferably between 1° and 15°, more preferably between 5° and 11°, and most preferably 8°.

In the embodiment of FIGS. 1 to 5, the curved tubular portion 12 is hollow and an inner area a1 of the hollow curved tubular portion 12 of the handle 10 perpendicular to a longitudinal center axis X1 of the curved tubular portion 12 increases towards the first gripping end 10a of the handle 10. This creates sort of a backstop for the handle 10 without needing to increase the wall thickness of the hollow curved tubular portion 12. This backstop decreases the chance of the handle 10 slipping from the user's hand when using the axe 1.

In the embodiment of FIGS. 1 to 5, the second end 10b of the handle 10 partially surrounds the axe head 20 in a longitudinal direction X2 of the straight tubular portion 11 of the axe 1, such that it delimits relative movement of said parts in said longitudinal direction X2. In other words, the second end 10b of the handle 10 is provided with an opening, and the axe head 20 protrudes through the opening. This allows the handle 10 to be manufactured around the axe head 20 with i.e. injection molding, instead of manufacturing said parts separately and then connecting said parts together.

In the embodiment of FIGS. 1 to 5, the curved portion 12 comprises a surface portion 30. The surface portion 30 enhances the comfort of the handle 10 and improves the grip of the user. The surface portion 30 is preferably softer than rest of the handle 10. The surface portion 30 may also further comprise surface texture, particularly in form or recesses or protrusions in order to improve the grip and to reduce the possibility of the user's hand slipping when using the axe 1.

The material of the handle 10 is preferably a polyamide (PA) reinforced with 30-40% glass fiber.

The material of the filling or filling part 13 is preferably manufactured of similar polyamide (PA) with 30-40% glass fiber as the handle 10 of the axe. This is advantageous as it provides increased adhesion between the filling and the handle 10. Other materials may also be used such as poly propane, available as waste plastic, for instance.

The material of the axe head 20 may be carbon steel, for instance. However, other axe head materials such as stainless steel may also be used.

The material of the surface part is preferably a thermoplastic elastomer (TPE), in particular styrene-ethylene-butylene-styrene (SEBS).

The axe 1 may be an axe intended for one-handed use. Such axes are generally smaller, than axes intended for two-handed use. In axes mainly intended for one-handed use, this curvature of the handle 10 is especially advantageous as it is the sole contact point between the user and the axe when the axe 1 is used.

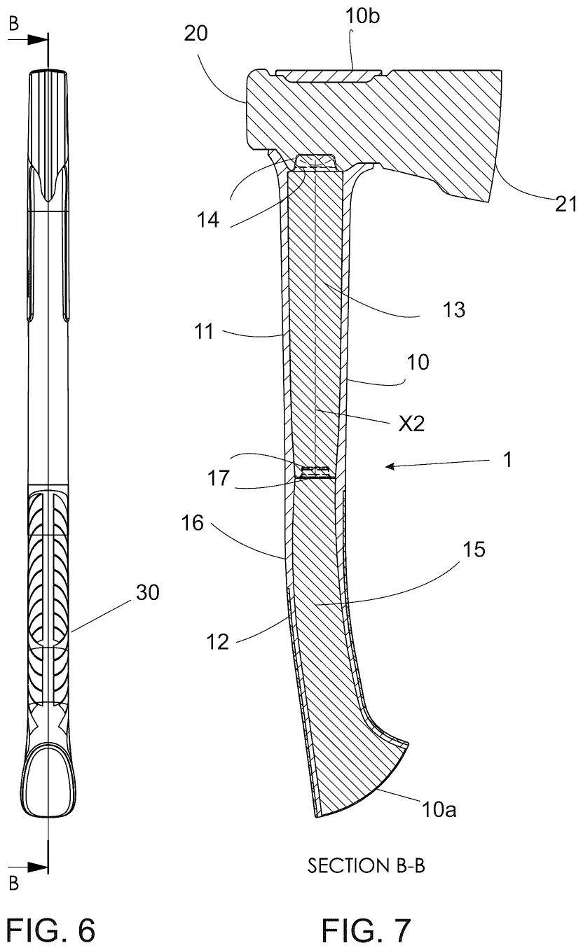

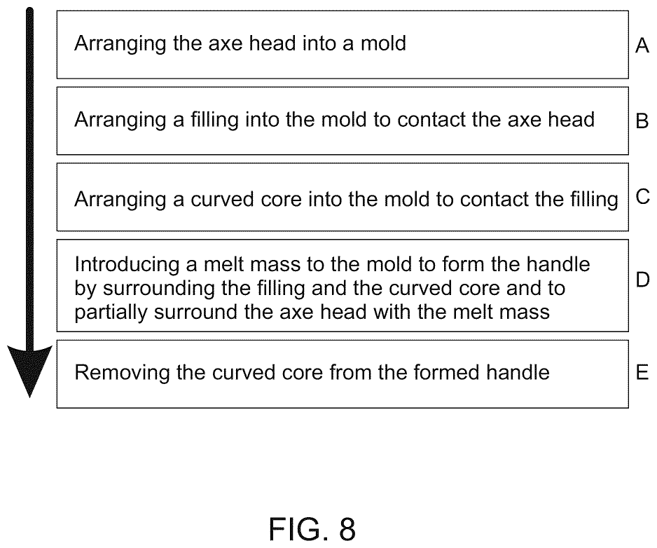

FIG. 8 illustrates a flow chart of an embodiment of a manufacturing method for manufacturing an axe 1. This method may be implemented for manufacturing the axe illustrated in FIGS. 1-7, for instance. For instance, an injection molding machine can be used for executing the manufacturing steps. The embodiment method comprises steps of A arranging the axe head 20 into a mold, arranging B a filling into the mold to contact the axe head 20, arranging C a curved core 15 into the mold to contact the filling, introducing D a melt mass to the mold to form the handle 10 by surrounding the filling and the curved core 15 and to partially surround the axe head 20 with the melt mass. And removing E the curved core 15 from the formed handle 10 once the handle 10 is cured. With these steps an improved axe can be easily manufactured, with high quality and repeatability of the process.

The first steps illustrated in the flow chart requires a premade axe head 20, a mold for the axe 1, either arranging a suitable filling or providing a premade filling part 13, and a curved core 15. These required parts are then inserted to the mold accordingly into correct positions. Once the parts are in position inside the mold, the mold can be filled with the melt mass to fill the void spaces between the mold and the parts inside the mold. Once the mold has been filled, the axe 1 is allowed to cure before opening the mold and removing the axe 1 from the mold.

Preferably, the curved core 15 is removed by extracting the curved core 15 from the mold in a curved path corresponding with the curvature of the curved core 15.

Preferably if a filling part 13 is used, the filling part 13 and axe head 20 are shaped to have compatible positioning elements improving the accuracy and throughput time of the manufacturing method, and to make sure the parts are aligned correctly. The filling part 13 may be locked to the axe head 20 with said positioning elements.

Optionally, also the curved core 15 and the filling may have compatible positioning elements improving the accuracy and throughput time of the manufacturing method, and to make sure the parts are aligned correctly. Correspondingly, the curved core 15 may be locked to the filling with said positioning elements.

Preferably, the mold and the curved core 15 are dimensioned to mutually obtain a wall thickness in at least a part of the curved portion 12. This dimensioning ensures that the properties of the axe 1 are as intended, and that the curing of the handle 10 is even.

It is to be understood that the above description and the accompanying figures are only intended to illustrate the present invention. It will be obvious to a person skilled in the art that the invention can be varied and modified without departing from the scope of the invention.

What is claimed is:

1. A method for manufacturing an axe, the method comprising:
arranging an axe head into a mold;
arranging a filling into the mold to contact the axe head;
arranging a curved core into the mold to contact the filling;
introducing a melt mass to the mold to form a handle by surrounding the filling and the curved core and to partially surround the axe head with the melt mass; and
removing the curved core from the formed handle.

2. The method according to claim 1, further comprising:
utilizing a filling part as the filling;
shaping the filling part and the axe head to have compatible positioning elements; and
locking the filling part to the axe head with the positioning elements.

3. The method according to claim 1, further comprising:
shaping the curved core and the filling to have compatible positioning elements; and
locking the curved core to the filling for positioning the curved core in the mold.

4. The method according to claim 1, further comprising dimensioning the mold and the curved core mutually to obtain a constant wall thickness in at least a part of a curved tubular portion.

5. The method according to claim 1, further comprising wherein the curved core is removed from the mold along a curved path corresponding a curvature of the curved core.

6. The method according to claim 1, wherein the filling is solid.

7. The method according to claim 6, wherein the filling is formed of a polyamide material and a glass fiber material.

8. The method according to claim 1, wherein the filling defines an infill portion.

9. The method according to claim 1, further comprising, before removing the curved core from the formed handle, curing the handle.

10. The method according to claim 4, wherein the handle comprises a straight tubular portion and the curved tubular portion.

11. The method according to claim 10, wherein the straight tubular portion comprises the filling.

12. The method according to claim 10, wherein the curved tubular portion comprises a surface portion.

13. The method according to claim 12, wherein the surface portion comprises a plurality of recesses and protrusions to form a textured surface.

14. The method according to claim 2, wherein:
the axe head defines a recess, the recess being one of the compatible positioning elements; and
the filling part comprises a protrusion, the protrusion another one of the compatible positioning elements.

15. The method according to claim 14, wherein the protrusion extends into the recess to delimit relative movement of the axe head and the filling part.

16. The method according to claim 10, wherein the handle comprises a first gripping end such that an angle is formed between the first gripping end and the straight tubular portion.

17. The method according to claim 16, wherein the angle is between 1 degree and 15 degrees.

18. The method according to claim 17, wherein the angle is between 5 degrees and 11 degrees.

19. The method according to claim 1, wherein the melt mass is formed of a thermoplastic elastomer material.

20. The method according to claim 1, wherein, before arranging the axe head into the mold, the axe head is formed of a carbon steel material.
